(19) United States
(12) Patent Application Publication
(10) Pub. No.: US 2017/0135103 A1
(43) Pub. Date: May 11, 2017

(54) ANTENNA-BASED PROCESSING METHOD AND ANTENNA-BASED PROCESSING DEVICE

(71) Applicants: LE HOLDINGS (BEIJING) CO., LTD., Beijing (CN); Lemobile Information Technology (Beijing) Co., Ltd., Beijing (CN)

(72) Inventors: Bo CHENG, Beijing (CN); Kang LU, Beijing (CN)

(21) Appl. No.: 15/249,233

(22) Filed: Aug. 26, 2016

Related U.S. Application Data
(63) Continuation of application No. PCT/CN2016/089117, filed on Jul. 7, 2016.

(30) Foreign Application Priority Data
Nov. 6, 2015 (CN) 201510756375.5

(51) Int. Cl. H04W 72/04; H04W 24/08; H01Q 1/24

(52) U.S. Cl. CPC H04W 72/0453; H01Q 1/243; H04W 24/08

(57) ABSTRACT

An embodiment of the present disclosure discloses an antenna-based processing method and an antenna-based processing device. The method comprises: monitoring network signals of mobile devices to determine frequency bands occupied by the network signals; determining target feed points to be connected with metal antennas according to the frequency bands; switching to the target feed points to be connected, configuring electrical lengths of the metal antennas according to the target feed points, so as to receive and send radio-frequency signals. According to the antenna-based processing method disclosed by the embodiment of the present disclosure, the electrical lengths of the metal antennas can be changed, thus the metal antennas can achieve sizes required by signal radiation at various frequency bands, thereby receiving and sending the radio-frequency signals at different frequency bands, improving the antenna efficiency, and solving problems of narrow antenna widths.

### CROSS-REFERENCE TO RELATED APPLICATIONS

This application is a continuation of International Application No. PCT/CN2016/089117, filed on Jul. 7, 2016, which is based upon and claims priority to Chinese Patent Application No. 201510756375.5, filed on Nov. 6, 2015, the entire contents of which are incorporated herein by reference.

### TECHNICAL FIELD

The present disclosure generally relates to the field of wireless communication technology, in particular to an antenna-based processing method and an antenna-based processing device.

### BACKGROUND

With the rapid development of communication technology, especially with the popularization of mobile Internet, mobile devices have become more popular, and are now one of the most important communication tools in people's lives and work. Antennas are unique components for connecting the mobile devices to a network, and play a role in sending and receiving signals, so that performance optimization of the antennas is becoming more and more important.

With the development of data communication and multimedia business requirements, mobile devices are required to support greater of frequency bands to comply with people's communication requirements. Taking mobile phones as an example, due to the popularization of 4th generation mobile communication technology, mobile phones are required to support greater of frequency bands, and covering a dozen of frequency bands between 700 and 2700 MHz, such as the frequency band 2600 MHz, the frequency band 2500 MHz, the frequency band 2300 MHz, the frequency band 1900 MHz, the frequency band 1700 MHz, the frequency band 1800 MHz, frequency band 900 MHz, the frequency band 850 MHz, the frequency band 700 MHz, etc.

To guarantee effective radiation of the antennas, physical sizes of the antennas in any direction are required to be compatible with radiated electromagnetic wavelengths, such that monopole antennas used in the mobile phones are quarter wave. Generally, patterns of non all-metal antennas of the mobile devices are designed according to flexible printed circuit board (FPC) or laser-direct-structuring (LDS), thereby achieving the sizes required by radiation at various frequency bands.

However, the design of the all-metal antennas is strictly limited to industrial design (ID) and mechanical strength, which prevents the patterns of non all-metal antennas from being designed via FPC or LDS; thus the sizes required by signal radiation at various frequency bands are difficult to achieve. Therefore, the efficiency of the all-metal antennas is low; the high, middle and low frequency bands are not balanced; namely the bandwidths are narrow.

### SUMMARY

An embodiment of the present disclosure discloses an antenna-based processing method and an antenna-based processing device to solve problems that all-metal antennas are low in efficiency and narrow in bandwidth.

According to an aspect of the present disclosure, the embodiment of the present disclosure discloses an antenna-based processing method, including:
monitoring network signal of the mobile device to determine frequency band occupied by the network signal;
determining target feed point to be connected with the metal antenna according to the frequency band;
switching to the target feed points to be connected, configuring electrical length of the metal antenna according to the target feed point, so as to receive and send radio-frequency signal.

Correspondingly, according to the other aspect of the present disclosure, the embodiment of the present disclosure further discloses an antenna-based mobile device, including: at least one processor; and a memory communicably connected with the at least one processor for storing instructions executable by the at least one processor, wherein execution of the instructions by the at least one processor causes the at least one processor to:
monitor network signal of mobile device, determine frequency band occupied by the network signal;
determine target feed point to be connected with metal antenna according to the frequency band;
switch to the target feed point to be connected, and configure electrical length of the metal antenna according to the target feed point, so as to receive and send radio-frequency signal.

According to another aspect of the present disclosure, the present disclosure provides a computer program, including computer readable codes; when the computer readable codes are run on the mobile devices, the mobile devices carry out the antenna-based processing method.

According to another aspect of the present disclosure, the present disclosure provides a computer readable medium in which the computer program is saved.

Compared with the prior art, the embodiment of the present disclosure has the following advantages:
according to the embodiment of the present disclosure, as a way of monitoring the network signals, the frequency bands occupied by the network signals and the target feed points to be connected with the metal antennas can be determined; as a way of switching to the target feed points, the electrical lengths of the metal antennas can be changed, so that the metal antennas can achieve the sizes required by the signal radiation at various frequency bands, thereby receiving or sending the radio-frequency signals at different frequency bands, improving the efficiency of the antennas, and solving problems that the bandwidths of the antennas are narrow.

Description above is an overview of the technical scheme in the present disclosure. In order to more clearly understand the technical means in the present disclosure, the technical means can be carried out according to the contents of the description. In order to make the objectives above, other objectives, characteristics and advantages of the present disclosure more easy to understand, embodiments of the present disclosure are illustrated as follows.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a structure diagram of an all-metal mobile phone antenna.

FIG. 2 is a step flow chart of an antenna-based processing method according to a first embodiment of the present disclosure.

FIG. 3 is a feed point switching diagram according to a first embodiment of the present disclosure.

FIG. 4 is a schematic diagram of switching feed points according to a first embodiment of the present disclosure.

FIG. 5 is a step flow chart of an antenna-based processing method according to a preferable embodiment of the present disclosure.

FIG. 6 is a structure diagram of an antenna-based processing device according to the present disclosure.

FIG. 7 is a structure diagram of an antenna-based processing device according to a preferable embodiment of the present disclosure.

FIG. 8 is a schematic diagram of the mobile device for carrying out the method according to the present disclosure.

FIG. 9 is a schematic diagram for maintaining or carrying a program code memory cell according to the method of the present disclosure.

### DETAILED DESCRIPTION

In order to clarify the objectives, technical schemes and advantages of the embodiments of the present disclosure, the technical schemes in the embodiments of the present disclosure are described clearly and integrally in a way that combines the drawings in the embodiments of the present disclosure. Obviously, the described embodiments are some embodiments of the present disclosure, rather than all embodiments. Based on the embodiments of the present disclosure, all of the other embodiments obtained by those skilled in the art without creative work are within the protection scope of the present disclosure.

Generally, the performances of the all-metal antennas of the mobile device are guaranteed at the expense of ID, namely the performances of the antennas are guaranteed by increasing the clearance area of the antennas by increasing the widths of metal gaps. Specifically, the antennas must have a function of radiating outwards, but fully-sealed metal cases are not feasible. Therefore, in order that the all-metal cases have the radiation function of the antennas, the all-metal shells are usually slotted.

It should be noted that the mobile devices are also called running devices, flow devices, handheld devices, etc. The mobile devices are computing devices, including but not limited to handheld game consoles, cell phones, mobile phones, tablet computers, etc. Users can access a variety of information via the mobile devices at any time and from anywhere.

Taking the antennas of the all-metal mobile phone as an example, the metal part of the back case of the all-metal mobile phone is the antennas. In order that electromagnetic signals can be effectively radiated into space, the back case of the all-metal mobile phone must be slotted to create radiators of the antennas. Bigger all-metal mobile phone with a same screen size affects the appearance and user's experience.

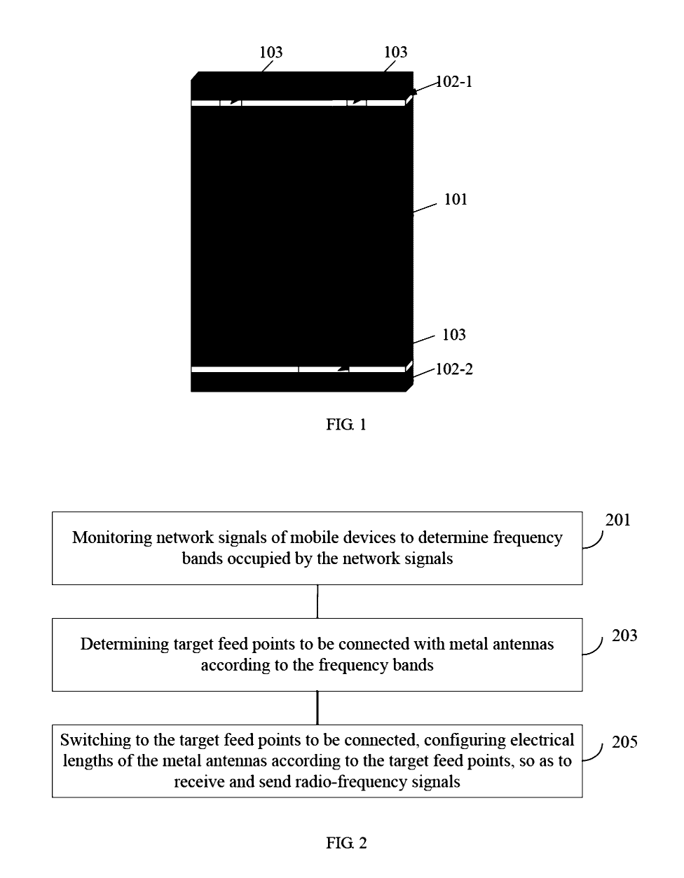

A structure diagram of an all-metal mobile phone antenna is shown in FIG. 1.

As shown in FIG. 1, in order to comply with radiation requirements of the antennas, the top and bottom of the metal back case are slotted separately, the white part in FIG. 1 is a non-metal part, namely the slots, thus the radiators 102-1 and 102-2 of the antennas are formed. The radiator 102-1 can be understood as a major antenna, the radiator 102-2 can be understood as a diversity antenna, namely an aux antenna, including but not limited to one or more of GPS antennas, Bluetooth antennas, WiFi antennas, FM headphone jack antennas and other antennas. A reference ground 101 is connected with the radiator via a connection bar 103. All-metal antennas are tuned according to positions and lengths of the connection bars of various parts as well as the widths of the slots.

Obviously, the design of the all-metal antennas is strictly limited to the demands of industrial design and mechanical strength, the form is single, and the sizes required by the signal radiation at various frequency bands are difficult to achieve. The all-metal antennas are narrow in bandwidth and low in efficiency. Therefore, the all-metal antennas become one of the design difficulties of the mobile devices.

In view of the above questions, one of the core ideas of the embodiment of the present disclosure is to change the positions on the all-metal back case where the radio-frequency signals are fed by switching the feed points of the antennas aiming at different frequency bands, namely changing the electrical lengths of the antennas, so that the metal antennas can achieve the sizes required by the signal radiation at various frequency bands, thereby receiving or sending the radio-frequency signals at the different frequency bands, improving the efficiency of the antennas, increasing the bandwidths of the antennas and achieving the purpose of optimizing the performances of the antennas.

A step flow chart of an antenna-based processing method according to a first embodiment of the present disclosure is shown in FIG. 2. The antenna-based processing method specifically includes: Step 201: Monitoring network signals of mobile devices to determine frequency bands occupied by the network signals.

Actually, the mobile devices can change their working frequencies by tuning the antennas, so as to support different frequency bands. The network signals connected to the mobile devices determine the working frequencies of the antennas of the mobile devices. The frequency bands occupied by the network signals can be determined by monitoring the network signals connected with the mobile devices; namely, the working frequencies of the antennas of the mobile devices can be determined.

Specifically, which frequency the radio-frequency signals work at is controlled by the network and basebands. Therefore, when the network signals of the mobile devices are changed, the frequency bands occupied by the network signals of the mobile devices can be determined by monitoring, and then the working frequencies at which the mobile devices send or receive the radio-frequency signals can be determined. The mobile devices can receive or send the radio-frequency signals of the working frequencies by tuning the antennas of the mobile devices. It should be noted that different network signals occupy different frequency bands; such as the network signal GSM-850 occupies the frequency band 824-894 MHz, the network signal GSM-900 occupies the frequency band 890-960 MHz, the network signal DCS-1800 occupies the frequency band 1710-1880 MHz, PCS1900 occupies the frequency band 1850-1990 MHz, etc., which is not limited to the embodiment of the present disclosure.

Step 203: Determining target feed points to be connected with metal antennas according to the frequency bands.

When determining the frequency bands occupied by the network signals, the mobile devices can determine the feed points correspondingly connected to the frequency bands according to the preset feed points correspondingly connected to various frequency bands; the feed points correspondingly connected to the frequency bands are adopted as the target feed points, namely the target feed points to be connected with the metal antennas. Specifically, the mobile devices can configure a plurality of feed points, and the electrical lengths of the antennas corresponding to various feed points are different. The electrical lengths of the antennas can be understood as ratios of the physical sizes to the radiated electromagnetic wavelengths of the antennas. The electrical lengths of the antennas can be changed by connecting the metal antennas to different feed points, thereby achieving the sizes required by the signal radiation at various frequency bands; such as, the mobile devices can configure the feed point 1 to the frequency band 900 MHz, configure the feed point 2 to the frequency band 1800 MHz, configure the feed point 3 to the frequency band 1900 MHz, configure the feed point 4 to the frequency band 2500 MHz and so on. Those skilled in the art can configure the number of the feed points and the frequency bands corresponding to various feed points according to the frequency bands of the signals supported by the mobile devices, but this is not limited to the embodiment of the present disclosure.

According to a preferable embodiment of the present disclosure, the method further includes: determining the frequency bands corresponding to the feed points connected with various ports by testing in advance, and then establishing the correspondences between the frequency bands and the feed points. The step of determining the target feed points to be connected with the metal antennas according to the frequency bands includes: searching the feed points corresponding to the frequency bands, and adopting the feed points as the target feed points to be connected with the metal antennas. According to the embodiment of the present disclosure, as a way of testing the metal antennas, at various frequency bands, better reception and transmission results of the radio-frequency information can be obtained by determining the ports through which the switches are connected with the feed points, thereby determining the ports connected to the switch at various frequency bands, namely the feed points corresponding to various frequency bands. Therefore, a feed point may correspond to one or more frequency bands, such as the frequency band 1800 MHz and the frequency band 1900 MHz correspond to the same frequency band; the correspondences between the frequency bands and the feed points can be determined according to actual requirements and test results, but this is not limited to the embodiment of the present disclosures.

Step 205: Switching to the target feed points to be connected, configuring electrical lengths of the metal antennas according to the target feed points, so as to receive and send radio-frequency signals.

In specific implementation, electric switches of the mobile devices include a plurality of ports, and each port is connected with a feed point. The electric switches are equivalent to feed point switches, called switches for short. Which frequency band the mobile devices work at is controlled by the basebands of the mobile device, the feed point switches can be switched to the best feed points according to the testing results of the antennas obtained in advance. Specifically, in a process of debugging the antennas, in order to achieve the performance requirements, the mobile devices can be switched to different ports via the electric switches, so as to be connected with different feed points. For different frequency bands, the mobile devices can configure different connection feed points of the metal antennas, wherein the electrical lengths corresponding to various feed points are different. The mobile devices can configure the electrical lengths of the metal antennas according to the target feed points, so that the antennas of the mobile antennas can achieve the sizes required by signal (i.e. radio frequency) radiation at various frequency bands, thereby receiving or sending the radio frequency signals.

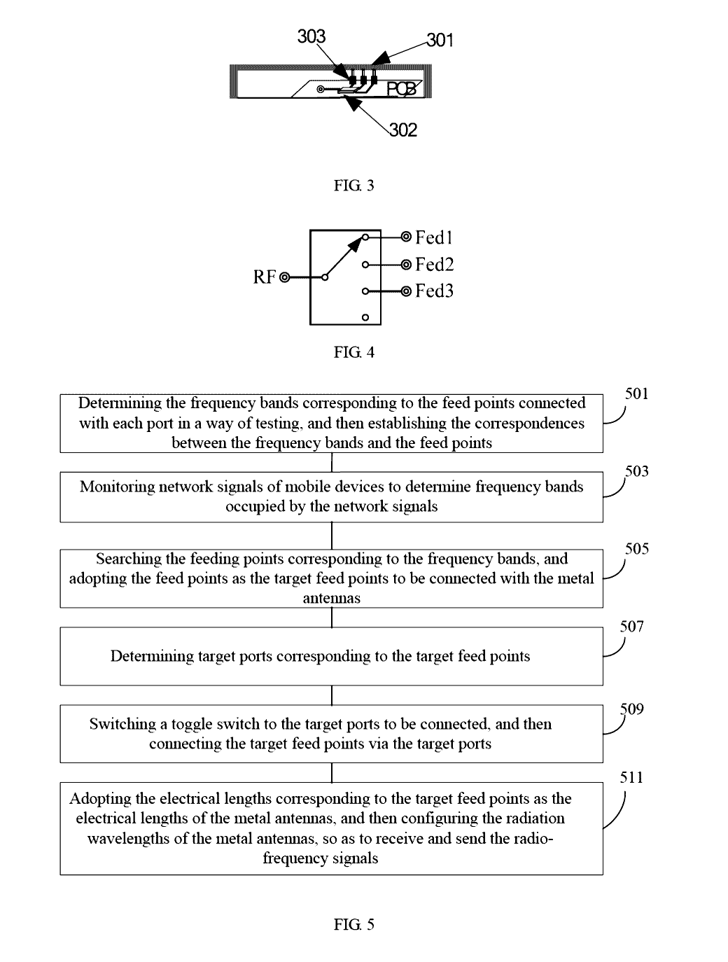

As a specific embodiment of the present disclosure, the mobile devices can configure three feed points. A feed point switching diagram according to a first embodiment of the present disclosure is shown in FIG. 3. The part 301 is the metal back case, the part 302 is the feed point switch, and the part 303 is the connection part. A schematic diagram of switching feed points according to a first embodiment of the present disclosure is shown in FIG. 4. The radio-frequency signal is called radio frequency (RF) for short, understood as an electromagnetic wave radiated to space. The feed point Fed1 corresponds to the frequency band 900 MHz, the feed point Fed2 corresponds to the frequency band 1800 MHz, and the feed point Fed3 corresponds to the frequency band 250,000 MHz. In the process of debugging the antennas, the mobile devices can configure on the bottom radio-frequency drive: when the radio-frequency signal works at the frequency band 900 MHz, the feed point switch is switched to the feed point Fed1; when the radio-frequency signal works at the frequency band 1800 MHz, the feed point switch is switched to the feed point Fed2: when the radio-frequency signal works at the frequency band 2500 MHz, the feed point switch is switched to the feed point Fed3.

According to a preferable embodiment of the present disclosure, the step of switching to the target feed points includes:
sub-step 20501, determining target ports corresponding to the target feed points;
sub-step 20503, switching a switch to the target ports to be connected, and then connecting the target feed points via the target ports.

According to another preferable embodiment of the present disclosure, the step of configuring the electrical lengths of the metal antennas according to the target feed points includes: adopting the electrical lengths corresponding to the target feed points as the electrical lengths of the metal antennas, and then configuring the recitation wavelengths of the metal antennas.

For different frequency bands, according to the embodiment of the present disclosure, the positions on the all-metal back case where the radio-frequency signals are fed can be changed by switching the feed points of the antennas, namely changing the electrical lengths of the antennas, so that the metal antennas can achieve the sizes required by the signal radiation at various frequency bands, thereby receiving or sending the radio-frequency signals at different frequency bands, increasing the bandwidths of the antennas while improving the efficiency of the antennas, thus achieving the purpose of optimizing the performances of the antenna.

In order that those skilled in the art can better understand the embodiment of the present disclosure, the embodiment of the present disclosure is described with the following preferable embodiments.

A step flow chart of an antenna-based processing method according to a first embodiment of the present disclosure is shown in FIG. 5. The antenna-based processing method specifically includes:

Step 501: Determining the frequency bands corresponding to the feed points connected with various ports by testing in advance, and establishing correspondences between the frequency bands and the feed points.

Actually, before delivered, the mobile devices can determine the radiation capacity the feed points connected with various ports of the feed point switches at the various frequency bands can be determined by testing, thereby determining the feed points with the best radiation capacity corresponding to various frequency bands. For various frequency points, the feed points with the best radiation capacity are configured as the target feed points at the frequency bands, namely establishing the correspondences (equivalent to antenna test results) between the frequency points of the feed points; thus the metal antennas can achieve the electrical lengths required by the signal radiation at various frequency bands by switching the feed points, the efficiency of the antennas is improved, and the purpose of optimizing the performances of the antennas is achieved.

Step 503: Monitoring network signals of mobile devices to determine frequency bands occupied by the network signals.

Step 505: Searching the feeding points corresponding to the frequency bands, and adopting the feed points as the target feed points to be connected with the metal antennas.

After the frequency bands occupied by the network signals are determined, the feed points corresponding to the occupied frequency bands can be determined by way of searching the correspondences between the frequency bands and the feed points, and the determined feed points can be adopted as the target feed points to be connected with the metal antennas.

Step 507: Determining target ports corresponding to the target feed points.

Step 509: Switching a switch to the target ports to be connected, and then connecting the target feed points via the target ports.

According to the embodiment of the present disclosure, various ports of the switches of the mobile devices are separately connected with the feed points of the antennas. Each port is connected with a feed point of the antennas, namely there are as many feed points of the antennas as there are ports of the switch: for example, if there are three antenna feed points, the switch has three ports; if there are four antenna feed points, the switch has four ports; if there are five antenna feed points, the switch has five ports, and so on, which is not limited to the embodiment of the present disclosure.

After the target feed points are determined, the ports of the switch to be connected with the target feed points can be determined as the target ports. The mobile devices can be connected to the target feed points by switching the switch to the target ports, namely switching the switch to the best feed points according to the antenna test results obtained in advance. Taking that the switch of the mobile device has three ports as an example, as shown in FIG. 3, the first port is connected to the feed point Fed1, the second port is connected to the feed point Fed2, and the third port is connected to the feed point Fed3. For example, when the radio-frequency signal works at the frequency band 900 MHz, if the switch is switched to the first port (equivalent to the target port) connected to the target feed point Fed1, namely the target feed point Fed1 can be connected via the target port; thus the antennas of the mobile devices can achieve the sizes required by the signal radiation at the frequency band 900 MHz, the efficiency of the antennas is guaranteed, and the performances of the antennas are optimized.

Step 511: Adopting the electrical lengths corresponding to the target feed points as the electrical lengths of the metal antennas, and then configuring the radiation wavelengths of the metal antennas, so as to receive and send the radio-frequency signals.

According to a preferable embodiment of the present disclosure, the method further includes a step of determining the electrical lengths of the feed points: acquiring the physical lengths of the metal antennas of the mobile devices; determining the electrical lengths of the feeding points according to the radiation wavelengths of various feed points and the physical lengths of the metal antennas.

Actually, the radiation frequencies of the radio-frequency signals at the frequency bands can be determined according to the frequency bands occupied by the network signals, thereby determining the radiated electromagnetic wavelengths at the frequency bands. The radiation wavelengths corresponding to various feed points can be determined according to the correspondences between the feed points and the frequency bands as well as the radiated electromagnetic wavelengths at various frequency bands. The electrical lengths of the antennas are ratios of the physical sizes to the radiated electromagnetic wavelengths of the antennas. The electrical lengths of various feed points can be determined according to the acquired physical lengths of the metal antennas of the mobile devices, the radiation wavelengths corresponding to various feed points and the physical lengths of the metal antennas of the mobile devices.

After being connected to the target feed points, the mobile devices can receive or send the radio-frequency signals via the target feed points. Specifically, the electrical lengths corresponding to the target feed points can be adopted as the electrical lengths of the metal antennas, the radiation wavelengths of the metal antennas can be configured according to the electrical lengths and the physical lengths of the antennas, and the radio-frequency signals can be received or sent according to the radiation wavelengths (or radiation frequencies).

According to the embodiment of the present disclosure, the positions on the all-metal back case where the radio-frequency signals are fed can be identified by switching the feed points of the antennas; thus the all-metal antennas of the mobile devices can achieve the sizes required by the radiation at various frequency bands, the bandwidths of the antennas are increased, and the efficiency of the all-metal antennas is improved. According to the embodiment of the present disclosure, the purpose of optimizing the performances of the all-metal antennas of the mobile devices can be achieved by switching the feed points connected to the antennas, and realizability is high.

It should be noted that in order to simply describe the embodiment of the method, the embodiment is described as a series of action combinations, but those skilled in the art shall know that the embodiments of the present applications are not limited by the described action sequence, because some steps can be carried out according to other sequences or implemented at the same time according to the embodiments of the present disclosure. Secondly, those skilled in the art shall also know that the embodiments described in the description are preferable embodiments, and the related actions are not necessary to the embodiments of the present disclosure.

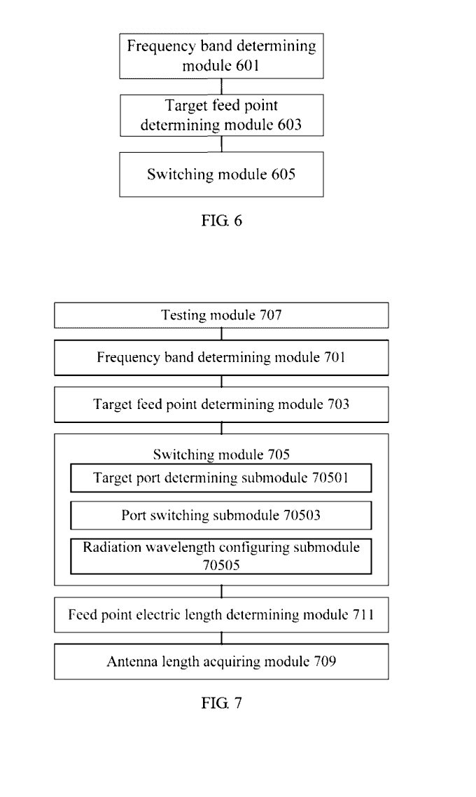

A structure diagram of an antenna-based processing device according to a first embodiment of the present disclosure is shown in FIG. 6. The antenna-based processing device specifically includes the following modules:
a frequency band determining module 601, configured to monitor the network signals of the mobile devices, so as to determine the frequency bands occupied by the network signals;
a target feed point determining module 603, configured to determine the target feed points to be connected with the metal antennas according to the frequency bands;
a switching module 605, configured to switch to the target feed points to be connected, and configure the electrical lengths of the metal antennas according to the target feed points, so as to receive and send radio-frequency signals.

A structure diagram of an antenna-based processing device according to a preferable embodiment of the present disclosure is shown in FIG. 7. The antenna-based processing device specifically includes:
a frequency band determining module 701, configured to monitor the network signals of the mobile devices, so as to determine the frequency bands occupied by the network signals;
a target feed point determining module 703, configured to determine the target feed points to be connected with the metal antennas according to the frequency bands;
a switching module 705, configured to switch to the target feed points to be connected, and configure the electrical lengths of the metal antennas according to the target feed points, so as to receive and send radio-frequency signals.

According to a preferable embodiment of the present discourse, the switching module 705 includes the following submodule:
a target port determining submodule 70501, configured to determine the target ports corresponding to the target feed points;
a port switching submodule 70503, configured to switch the switch to the target ports to be connected, and then connect the target feed points via the target ports;
optionally, the switching module 705 further includes a radiation wavelength configuring submodule 70505; a radiation wavelength configuring submodule 70505, configured to adopt the electrical lengths corresponding to the target feed points as the electrical lengths of the metal antennas, and then configure the radiation wavelengths of the metal antennas.

According to a preferable embodiment of the disclosure, the antenna-based processing device further includes a test module 707.

The test module 707 is configured to determine the frequency bands corresponding to the feed points connected with various ports by testing in advance, and establish the correspondences between the frequency bands and the feed points; correspondingly, a target feed point determining module 703 is configured to search the feeding points corresponding to the frequency bands, and adopt the feed points as the target feed points to be connected with the metal antennas.

Optionally, the antenna-based processing device further includes an antenna length acquiring module 709 and a feed point electric length determining module 711,
wherein the antenna length acquiring module 709 is configured to acquire the physical lengths of the metal antennas of the mobile devices; the feed point electrical length determining module 711 is configured to determine the electrical lengths of the feed points according to the radiation wavelength corresponding to various feed points and the physical lengths of the metal antennas.

As the device embodiment is similar to the method embodiment, the description is simple, and relevance is referred to the description of the method embodiment.

The embodiments in the description are all described gradually, and each embodiment mainly explains the difference from other embodiments, and the identical or similar parts of the embodiments are referred to each other.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

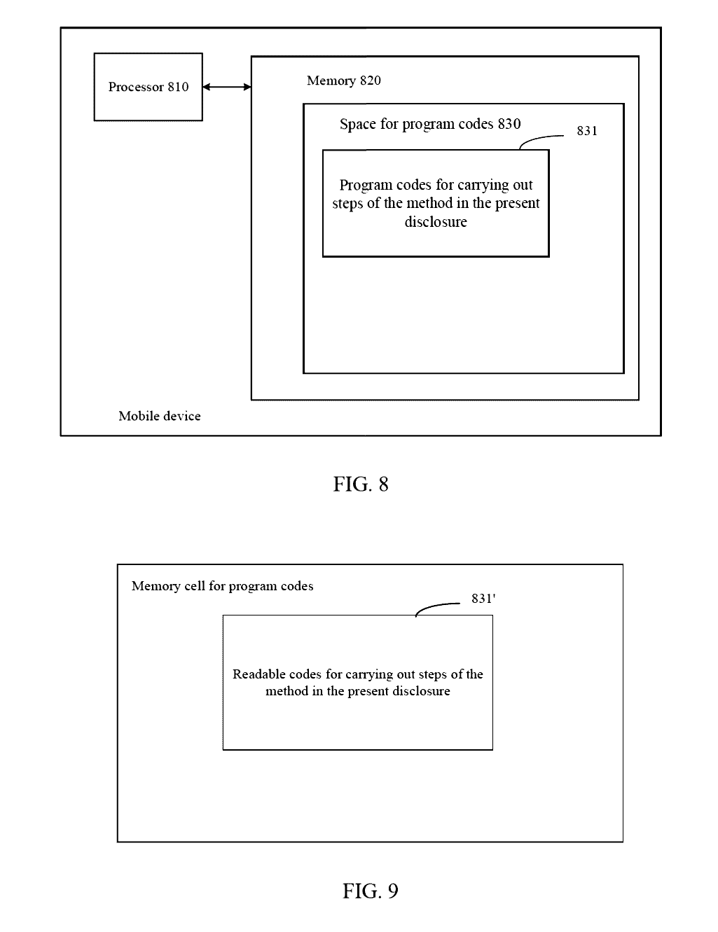

For example, FIG. 8 illustrates a block diagram of a mobile device for executing the method according the disclosure. Traditionally, the mobile device includes a processor 810 and a computer program product or a computer readable medium in form of a memory 820. The memory 820 could be electronic memories such as flash memory, EEPROM (Electrically Erasable Programmable Read—Only Memory), EPROM, hard disk or ROM. The memory 820 has a memory space 830 for executing program codes 831 of any steps in the above methods. For example, the memory space 830 for program codes may include respective program codes 831 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 9. The memory cells may be provided with memory sections, memory spaces, etc., similar to the memory 820 of the server as shown in FIG. 8. The program codes may be compressed for example in an appropriate form. Usually, the memory cell includes computer readable codes 831′ which can be read for example by processors 810. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

The embodiments of the present disclosure are all described gradually, and each embodiment mainly explains the difference from other embodiments, and the identical or similar parts of the embodiments are referred to each other. It is understood that computer program instructions can implement each flow and/or block in the flow chart and/or block diagram, or combinations of the flows and/or blocks in the flow chart and/or block diagram. The computer program instructions can be loaded on general-purpose computers, special-purpose computers, embedded processors or processors of other programmable data processing terminals to generate a machine, so that the instructions implemented by the computers or the processors of the other programmable data processing terminals can generate devices which can achieve the functions specified in a flow or multiple flows in the flow chart and/or a block or multiple blocks in the block diagram.

The computer program instructions can also be saved on computer readable memories which can lead the computers or other programmable data processing terminals to work in special manners, so that the instructions saved on the computer readable memories can generate products comprising instruction devices, the instruction devices can achieve the functions specified in a flow or multiple flows in the flow chart and/or a block or multiple blocks in the block diagram.

The computer program instructions can also be loaded on the computers or other programmable data processing terminals, so that a series of operations can be carried out in the computers or other programmable data processing terminals so as to generate the processes implemented by the computers: thus the instructions implemented on the computers or other programmable data processing terminals can be used in the steps of achieving the functions specified in a flow or multiple flows in the flow chart and/or a block or multiple blocks in the block diagram.

All of the above introduce an antenna-based processing method and an antenna-based processing device. In this article, the principles and implementation methods of the present disclosure are elaborated with specific examples, the description of the embodiments are only used for helping people understand the methods of the present disclosure and the core ideas thereof; at the same time, for those skilled in the art, the specific implementation methods and application ranges can be changed according to the idea of the present disclosure. In conclusion, the content of the description shall not be regarded as the limitations to the present application.

What is claimed is:

1. An antenna-based processing method, comprising:
monitoring a network signal of a mobile device to determine a frequency band occupied by the network signal;
determining a target feed point which needs to be connected with an metal antenna according to the frequency band;
switching to the target feed point to be connected, configuring electrical length of the metal antenna according to the target feed point, so as to receive and send a radio-frequency signal.

2. The method according to claim 1, wherein the method further comprises:
determining the frequency band corresponding to the feed point connected to port by testing in advance, and establishing correspondence between the frequency band and the feed point;
determining the target feed point which needs to be connected with the metal antenna according to the frequency band comprises:
searching the feeding point corresponding to the frequency band, and adopting the feed point as the target feed point which needs to be connected with the metal antenna.

3. The method according to claim 1, wherein switching to the target feed point to be connected comprises:
determining target port corresponding to the target feed point;
switching a switch to the target port to be connected, and then connecting the target feed point via the target port.

4. The method according to claim 1, wherein the method further comprises:
acquiring physical length of the metal antenna of the mobile device;
determining the electrical length of the feed point according to radiation wavelength corresponding to the feed point and the physical length of the metal antenna.

5. The method according to claim 1, wherein configuring the electrical length of the metal antenna according to the target feed point comprises:
adopting the electrical length corresponding to the target feed point as the electrical length of the metal antenna, and then configuring the radiation wavelength of the metal antenna.

6. An antenna-based mobile device, wherein the mobile device comprises:
at least one processor, and
a memory communicably connected with the at least one processor for storing instructions executable by the at least one processor, wherein execution of the instructions by the at least one processor causes the at least one processor to:
monitor a network signal of the mobile device, determine frequency band occupied by the network signal;
determine a target feed point which needs to be connected with the metal antenna according to the frequency band;
switch to the target feed point to be connected, and configure electrical length of the metal antenna according to the target feed point, so as to receive and send radio-frequency signal.

7. The mobile device according to claim 6, wherein execution of the instructions by the at least one processor causes the at least one processor to further:
determine the frequency band corresponding to the feed point connected to port by testing in advance, and establish correspondence between the frequency band and the feed point;
search the feeding point corresponding to the frequency band, and adopting the feed point as the target feed point to be connected with the metal antenna.

8. The mobile device according to claim 6, wherein switch to the target feed point to be connected, and configure electrical length of the metal antenna according to the target feed point, so as to receive and send radio-frequency signal comprises:
determine the target port corresponding to the target feed point;
switch a switch to the target port to be connected, and then connect the target feed point via target port.

9. The mobile device according to claim 6, wherein execution of the instructions by the at least one processor causes the at least one processor to further:
acquire physical length of the metal antenna of the mobile device;
determine the electrical length of the feed point according to radiation wavelength corresponding to each feed point and the physical length of the metal antenna.

10. The mobile device according to claim 6, wherein switch to the target feed point to be connected, and configure electrical length of the metal antenna according to the target feed point, so as to receive and send radio-frequency signal comprises:
adopt the electrical length corresponding to the target feed point as the electrical length of the metal antenna, and then configure the radiation wavelength of the metal antenna.

11. A non-transitory computer readable medium storing executable instructions that, when executed by a mobile device, cause the mobile device to:
monitor a network signal of the mobile device to determine a frequency band occupied by the network signal;
determine a target feed point which needs to be connected with an metal antenna according to the frequency band;
switch to the target feed point to be connected, configuring electrical length of the metal antenna according to the target feed point, so as to receive and send a radio-frequency signal.

12. The non-transitory computer readable medium according to claim 11, wherein the mobile device is further caused to:
determine the frequency band corresponding to the feed point connected to port by testing in advance, and establish correspondence between the frequency band and the feed point;
search the feeding point corresponding to the frequency band, and adopting the feed point as the target feed point to be connected with the metal antenna.

13. The non-transitory computer readable medium according to claim 11, wherein switch to the target feed point to be connected, and configure electrical length of the metal antenna according to the target feed point, so as to receive and send radio-frequency signal comprises:
determine the target port corresponding to the target feed point;
switch a switch to the target port to be connected, and then connect the target feed point via target port.

14. The non-transitory computer readable medium according to claim 11, wherein the mobile device is further caused to:
acquire physical length of the metal antenna of the mobile device;
determine the electrical length of the feed point according to radiation wavelength corresponding to each feed point and the physical length of the metal antenna.

15. The non-transitory computer readable medium according to claim 11, wherein switch to the target feed point to be connected, and configure electrical length of the metal antenna according to the target feed point, so as to receive and send radio-frequency signal comprises:
adopt the electrical length corresponding to the target feed point as the electrical length of the metal antenna, and then configure the radiation wavelength of the metal antenna.
